(19) United States
(12) Patent Application Publication
(10) Pub. No.: US 2014/0176517 A1
(43) Pub. Date: Jun. 26, 2014

(54) DISPLAY

(71) Applicant: DUGGAL ENERGY SOLUTIONS, LLC, New York, NY (US)

(72) Inventor: Abinand Rangesh, Brookline, MA (US)

(73) Assignee: Duggal Energy Solutions, LLC, New York, NY (US)

(21) Appl. No.: 13/724,162

(22) Filed: Dec. 21, 2012

(51) Int. Cl. G09G 5/10

(52) U.S. Cl. CPC G09G 5/10
USPC 345/207; 345/690; 345/87

(57) ABSTRACT

A display includes an electronic media, transparent, display screen. A translucent body is behind the display screen and a diffuser is between the display screen and the translucent body. Low power light sources direct light across the diffuser. The power source usually includes at least one solar panel.

### FIELD OF THE INVENTION

The present invention relates to displays and methods of illuminating transparent electronic media display screens.

### BACKGROUND OF THE INVENTION

Electronic media display screens can be attached to light poles and used for advertising, Kiosk type media, directions, alerts, and the like. See, for example, U.S. Pat. No. 7,630,776 incorporated herein by this reference.

To be visible, illumination for the screen is required such as backlighting. Backlighting technology, however, involves high power requirements and sometimes exceeds the power draw of all the other components of the display. The backlighting power draw requirements are even higher in outdoor applications where the screen has to be bright enough to be visible in sunlight.

In one example, a 22 inch LCD display screen with backlighting used 70-80 watts of power. When an electronic media display screen is attached to a light pole employing solar and/or wind power for energy to power the light pole lamp(s), there may not be sufficient available power for a display screen with backlighting or efficient power management for backlight purposes become critically important.

### SUMMARY OF THE INVENTION

In one embodiment, a solar and/or wind powered display with a 22 inch LCD electronic media display screen is adequately lit in varying ambient lighting conditions using only 10-20 watts of power. Reduction in the power required is effected, in one example, by the combination of a white translucent backing layer and a transparent diffusing layer with edge LEDs between the translucent backing layer and LCD screen.

Featured is a display comprising an electronic media, transparent, display screen. A translucent body is behind the display screen and a diffuser is between the display screen and the translucent body. Low power light sources direct light across the diffuser.

In one example, a power source for the display screen and the low power light sources include at least one solar panel. The display may further include a photosensor and a controller subsystem configured to control the application of power to the low power light sources based on ambient light levels as detected by the photosensor. In some versions, a receiver is included and the controller subsystem is further configured to receive content via the receiver and to display that content on the display screen. The receiver may have an IP address for receiving content via the internet.

The display may further include a frame about the display screen, the translucent body, and the diffuser and also a scratch resistant layer in front of the display screen. The display screen can be a transparent LCD screen and the low power light sources can be light emitting diodes.

Also featured is a display system comprising a pole, at least one solar panel, and a display. The display includes an electronic media, transparent, display screen powered by the solar panel, a translucent sheet behind the display screen, a diffusing sheet between the transparent screen and the translucent sheet, and low power light sources also powered by the solar panel and configured to direct light across the diffusing sheet. The display system may further include a battery for storing electricity generated by the solar panel.

Also featured is a method comprising procuring displays including an electronic media screen, installing them at or proximate customer locations, selling advertising rights to customers for display of customer advertising on the displays, activating the displays to run advertisements of the customers, receiving revenue from selling the advertising rights, and applying that revenue to the cost of procuring the displays.

In one example, a lessor procures the displays by purchasing them and sells advertising rights to customer lessees. In another example, a supplier of displays procures and installs the displays at a lessor's business and sells advertising rights to lessees of the lessor.

The subject invention, however, in other embodiments, need not achieve all these objectives and the claims hereof should not be limited to structures or methods capable of achieving these objectives.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a schematic exploded view showing the various components of a display in combination with a block diagram for the primary electronic components of a display system in accordance with one example of the invention;

FIG. 2 is a schematic view of the display system of FIG. 1 shown attached to a solar and wind powered lamp pole; and

FIG. 3 is a highly schematic view showing several displays in an outdoor malt in conjunction with a business method disclosed herein.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

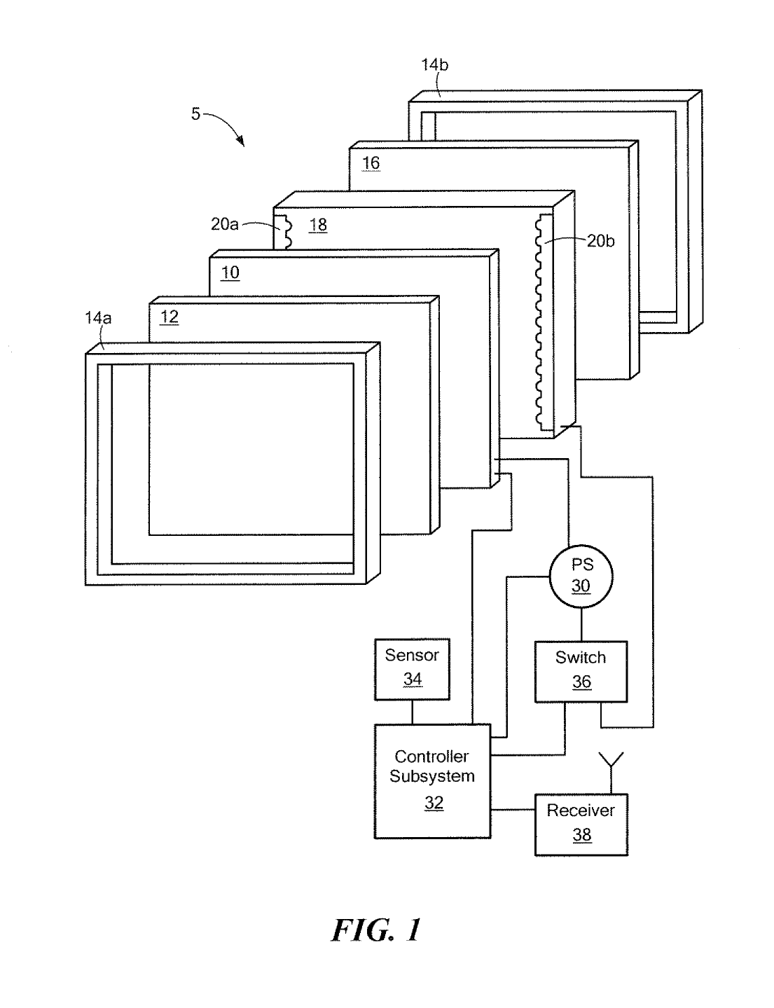

FIG. 1 shows electronic media, transparent or partially transparent, display screen 10 such as a 22 inch LCD screen. Use of a transparent screen enables viewing in ambient light conditions. Transparent/clear antiglare/antiscratch layer 12 may be included behind front frame portion 14a. An example of layer 12 is a sheet of Acrylite® non-glare (P-99) material available from Evonik Industries. Back sheet 16 is preferably a translucent sheet, white in color, and made of plastic. An example is the “SignFlex” (WDR58) product of Evonik Industries. Rear frame portion 14b is also shown and is a component of portion of, or otherwise coupled to front frame portion 14a.

Clear, colorless, transparent or translucent diffusing sheet 18 is between sheet 16 and screen 10 and preferably includes (e.g., is impregnated with) light diffusing particles. An example is the Plexiglas, “EndLighten T” product from Evonik.

In this way, ambient light incident on and passing through layer 12 also passes through screen 10. Light rays incident at an angle to diffusing sheet 18 are diffused and provide illumination for screen 10. Light rays normal to diffuser 18 pass through but are reflected back via sheet 16 and are diffused by sheet 18 and/or otherwise illuminate screen 10. Ambient light from the rear passes through sheet 16 and also strikes diffuser 18 providing illumination for screen 10. In outdoor applications, screen 10 is illuminated and is bright enough to be visible even in sunlight conditions.

For low ambient light level conditions, LED strips 20a and 20b on layer 18 and/or layer 16 are provided and have spaced LED lamps at a 0° or near 0° incidence angle across one surface of or across the interior of diffusing sheet 18 to illuminate screen 10. The LEDs may be edge mounted. The LEDs can be left on or turned on and off as a function of the ambient light level. Diffuser 18 emits LED light from both faces and light from the rear face is reflected back via back sheet 16. The LEDs can be on the top, bottom, and/or sides(s) of the layers 18 and/or 16. In other examples, translucent sheet 16 is combined with diffusing sheet 18 resulting in a single sheet which is diffusing (includes diffusing material) and translucent (includes translucent material) allowing light from the rear through and diffusing both said light and light passing through screen 10. The EVONIK Industries Acrylite Crystal Ice sheet is an example.

Power source 30 typically includes one or more solar panels and a battery or other storage means. Power source 30 provides power to screen 10, LEDs 20a and 20b, and controller subsystem 32 and/or other electronic or electric components of a complete display system 5. These devices can be disposed in frame 14.

In one example, controller subsystem 32 (e.g., a microcontroller, microprocessor, an application specific integrated circuit (ASIC), a programmable logic controller or equivalent) is programmed to be responsive to the output of a sensor 34 such as a photodiode and controls switch 36 to selectively energize edge LEDs 20a and 20b (only in low ambient light conditions, for example). In another example, sensor 34, controller 32, and switch 36 are subcomponents of a photocontroller. In other examples, the voltage and/or current levels applied to LEDs 20a and 20b are regulated (using, for example, pulse width modulation (PWM) techniques) to vary the output of the LEDs in response to the ambient light level as detected by sensor 34.

RF receiver 38 may be included to wirelessly receive media content to be displayed on screen 10. In one example, a smart phone includes receiver 38 and a processor 32. The smart phone has an internet address and/or cell phone number and thus can be accessed wirelessly to upload content to media screen 10.

Screen 10 thus preferably utilizes ambient light for illumination and the total operative power usage is in the range of 10-20 watts. Screen 10 is fully visible in bright sunlight with little or no LED edge lighting needed. In the absence of ambient light, the LED edge lighting illuminates display screen 10 hence limits power usage. An internet enabled media player can be used to receive play list information and to wirelessly update the information displayed on screen 10. Such a device can be programmed to split screen 10 into segments which can be used to display a combination of video and image information on the screen. Maps, directions, weather information, traffic information, and the like can also be uploaded to screen 10. Touch screen technology and the like and gesture recognition and the like can be incorporated to render screen system 5 interactive.

A two sided media display would include another LCD, white translucent sheet, and diffusing sheet combination and controller subsystem 32 could control both. Another diffusing sheet could be positioned on the other side of back sheet 16 and another LCD display could be disposed after the second diffusing sheet.

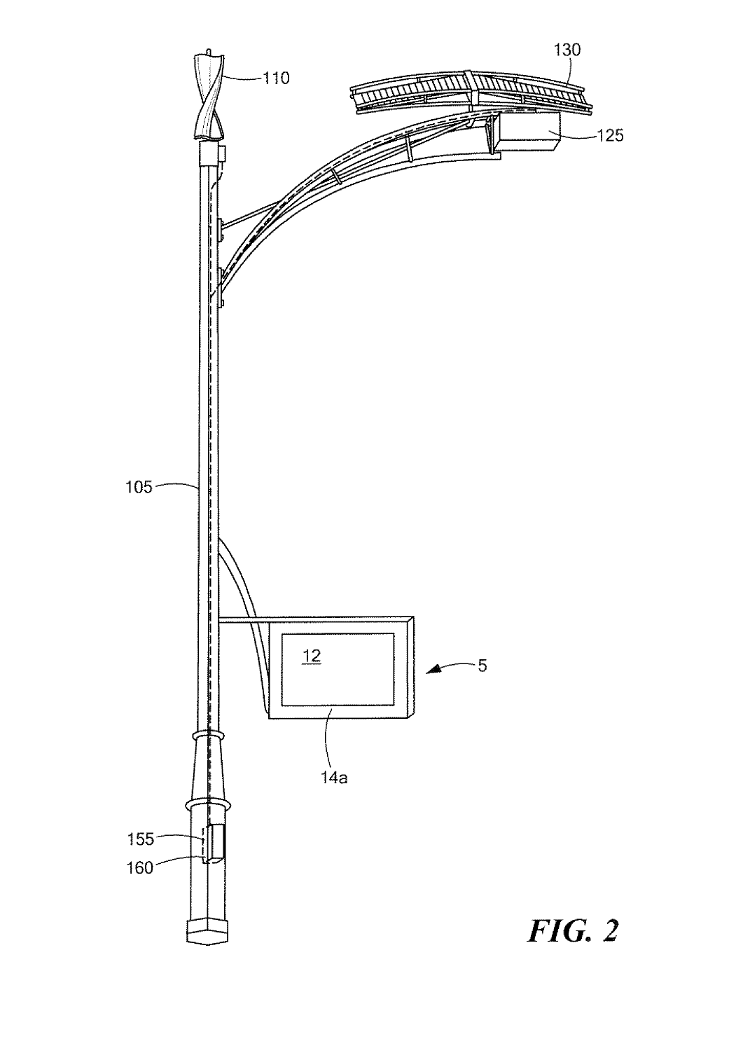

FIG. 2 shows display system 5 coupled to light pole 105. Light pole 105 also supports wind turbine 110, lamp 125, and solar array 130 which may include one or more solar panels. See published patent application No. US 2010/0220467 incorporated herein by this reference. Compartment 155 typically includes battery 160 charged by wind turbine 110 and/or solar array 130. Battery 160 then serves as power source 30, FIG. 1.

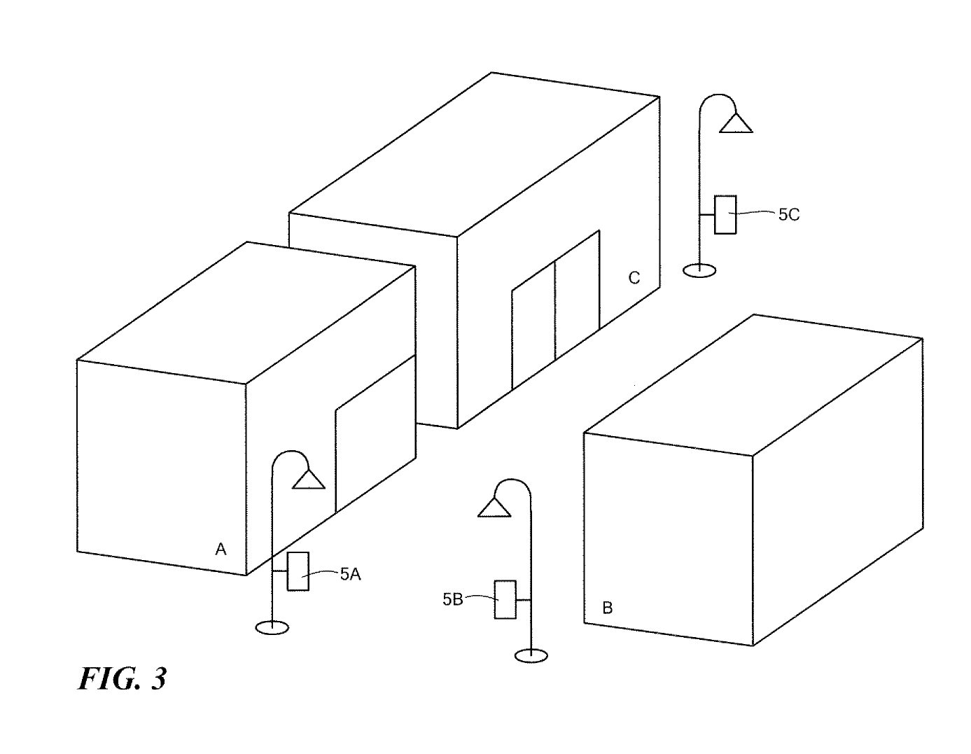

In FIG. 3, several such “media poles” are distributed at different locations of an outdoor mall. In accordance with one preferred method of the invention, the landlord or owner of the outdoor mall procures displays 5A, 5B, 5C and the like (and, optionally the light poles) and installs or has installed said displays proximate customer locations A, B, and C, respectively. The landlord or mall owner sells advertising rights to lessees for display of business advertising on the displays. For example, one merchant may lease retail establishment A from the landlord and desire that the merchant's advertising, sales information, and the like be continuously displayed on display 5A. Similarly, a restaurant leasing space at location B may desire the restaurant's menu to be continuously displayed on display 5B. The displays are configured as desired and the landlord or mall owner receives revenue from merchants A, B, C, and the like for the advertising rights on displays 5A, 5B, and 5C. That revenue is applied to (e.g., deducted from) the overall cost of procuring the displays (and the light poles as well, in some examples). Note too there is an incentive for Merchant C to control the advertising on display 5C lest merchant A purchase advertising rights for both screens 5A and 5C.

In another example, a supplier of displays and/or the light poles 5A, 5B, 5C, and the like (which could be a manufacturer) procures the displays and light poles either by purchasing them or having there manufactured and installs or has installed the displays at the businesses A, B, or C as shown in FIG. 3. The supplier then sells the advertising rights to the lessees A, B, and C of the lessor, typically the owner of the outdoor mall. In this way, the supplier recovers the cost of procuring the displays by directly receiving advertising revenue from lessees A, B, and C. In this way and in other equivalent methods, the media display system generates a positive cash flow stream.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

Other embodiments will occur to those skilled in the art and are within the following claims.

What is claimed is:

1. A display comprising:
an electronic media, transparent or partially transparent, display screen;
a translucent body behind the display screen;
a diffuser between the display screen and the translucent body; and
low power light sources directing light across the diffuser.

2. The display of claim 1 further including a power source for the display screen and the low power light sources.

3. The display of claim 2 in which the power source includes at least one solar panel.

4. The display of claim 1 further including a sensor and a controller subsystem configured to control the application of power to the low power light sources based on ambient light levels as detected by the sensor.

5. The display of claim 4 further including a receiver and wherein the controller subsystem is further configured to receive content via the receiver and to display said content on the display screen.

6. The display of claim 3 in which said receiver has an IP address for receiving content via the internet.

7. The display of claim 1 further including a frame about the display screen, the translucent body, and the diffuser.

8. The display of claim 1 further including a scratch resistant layer in front of the display screen.

9. The display of claim 1 in which the display screen is a transparent LCD screen.

10. The display of claim 1 in which the low power light sources are light emitting diodes.

11. A display system comprising:
a pole;
at least one solar panel on said pole;
a display attached to said pole, the display including:
an electronic media, transparent, display screen powered by the solar panel,
a translucent sheet behind the display screen,
a diffusing sheet between the transparent screen and the translucent sheet, and
low power light sources also powered by said solar panel and configured to direct light across the diffusing sheet.

12. The display system of claim 11 further including a battery for storing electricity generated by the solar panel.

13. The display system of claim 11 further including a photosensor and a controller subsystem configured to control the application of power to the low power light sources based on ambient light levels as detected by the photosensor.

14. The display system of claim 13 further including a receiver and wherein the controller subsystem is further configured to receive content via the receiver and to display said content on the display screen.

15. The display system of claim 14 in which said receiver has an IP address for receiving content via the internet.

16. The display system of claim 11 further including a frame about the display screen, the translucent sheet, and the diffusing sheet.

17. The display system of claim 11 further including a scratch resistant layer in front of the display screen.

18. The display system of claim 11 in which the display screen is a transparent LCD screen.

19. The display system of claim 11 in which the low power light sources are light emitting diodes.

20. A method comprising:
procuring displays including an electronic media screen;
installing said displays at or proximate customer locations;
selling advertising rights to customers for display of customer advertising on said displays;
activating said displays to run advertisements of said customers;
receiving revenue from selling of said advertising rights; and
applying said revenue to the cost of procuring the displays.

21. The method of claim 20 in which a lessor procures said displays by purchasing them, and sells advertising rights to customer lessees.

22. The method of claim 20 in which a supplier of displays procures said displays, installs said displays at a lessor's business, and sells advertising rights to lessees of a lessor.

23. A display comprising:
an electronic media, transparent or partially transparent, display screen;
a translucent material behind the display screen;
a diffuser behind the display screen; and
low power light sources directing light across the diffuser.

24. The display of claim 23 in which the translucent material and diffuser are combined in a sheet behind the display screen.

25. The display of claim 23 in which there is a diffuser sheet behind the display screen and a translucent sheet behind the diffuser sheet.
